(19) United States
(12) Patent Application Publication
(10) Pub. No.: US 2008/0062003 A1
(43) Pub. Date: Mar. 13, 2008

(54) Wireless controllable power control device molded into a power cable

(76) Inventor: Christian Paetz, Zwickau (DE)

Correspondence Address: GIBBONS P.C., ONE GATEWAY CENTER, NEWARK, NJ, 07102, US

(21) Appl. No.: 11/499,943

(22) Filed: Aug. 7, 2006

(51) Int. Cl. G08C 19/00

(52) U.S. Cl. 340/825.69; 307/117; 340/825.72; 307/115; 713/300

(57) ABSTRACT

A power control module is molded within a power cord or power cable. The module may include a wireless module, switches, controllers, relays, and power converters. The module may be powered by appropriately converting the power coming through the power cord or power cable. The power cord or cable is controlled wirelessly using wireless capable devices. The power control module responds to commands received from wireless devices, acts upon meeting set thresholds and collects and transmits data.

### FIELD OF THE INVENTION

The present invention relates to a power cable into which is molded a wireless controllable power control device.

### BACKGROUND OF THE INVENTION

Power management, the capability to switch, measure, and control power, is an increasingly important part of today's data center operation but also critical in other parts of the information technology (IT) world. Power Distribution Units (PDUs) or Power Control Units (PCUs) are prior art devices that deliver this functionality. In particular, the PDUs distribute power, but the PCUs also provide a control function. These devices typically offer multiple power outlets, for example, 8 . . . 24 outlets. For certain applications, where only a few power targets need to be controlled, a single or dual port PCU is best suited and these kinds of products are also available in the market. An example of a prior art PDU is the Sentry® Intelligent Power Module 2. This prior art device, however, lacks a wireless transceiver and is not usable in a server rack environment.

Another problem with the prior art PDUs and PCUs is that they create a lot of chaotic cabling in the server rack systems, particularly since the three connection cables, power in, power out, and control, make it very hard to place them in an well ordered fashion in the rack. IT system administrators and system integrators are very sensitive about making sure there are clear structured cablings in the rack cabinets.

There are also a couple of single port power switch units available from some suppliers. They all use a dedicated control wire to control the power switch units, which again results in chaotic cabling on the server rack systems.

Another prior art device is a wireless controlled switching device which uses 27 MHz open band wireless communication to switch power boxes. However, 27 MHz band is not suitable for a professional environment due to security risks and molding a power control switch device inside a cable is not known.

### BRIEF SUMMARY OF THE INVENTION

In accordance with one aspect of the invention, a power cord or power cable has a power control switch function or device that is molded into the cord or cable and is controlled using wireless technology. The power control switch device may be controlled by a PDA, a wireless capable PC or a wireless base station using conventional networking technologies and protocols. The power control switch device may include functional units such as switches, controllers, relays, and power converters. The electronics can be powered using the incoming power flowing through the power cord or cable. Since the power control switch device is encapsulated there is no need for galvanic segregation, thereby saving space that would otherwise be required for transformers.

### BRIEF DESCRIPTION OF THE DRAWINGS

In the drawings:

FIG. 1 shows a power extender cable with a wireless controllable power control switch device molded in the cable in accordance with the invention.

FIG. 2 shows a schematic circuit diagram of the power control switch device inside the cable in accordance with the invention.

### DETAILED DESCRIPTION OF THE INVENTION

For purposes of clarity, the initial discussion will include a basic description of the exemplary device. This will be followed by a presentation of an exemplary embodiment of the device. Finally, how a device would operate in accordance with the principles of the invention will be discussed.

### I. Overview

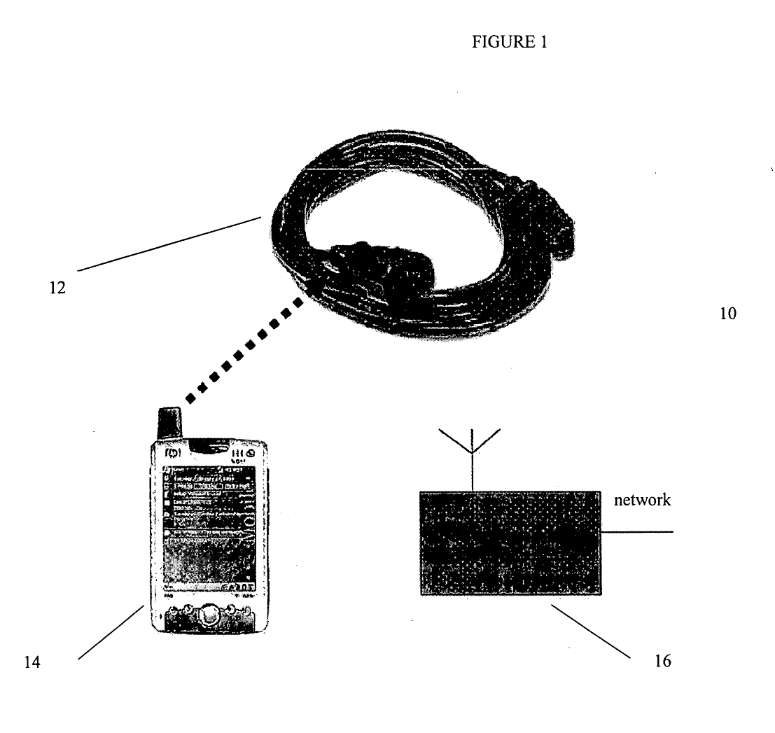

Turning to FIG. 1, a power cord or power cable 10 is shown in which is molded or encapsulated a power control switch device 12. Power control switch device 12 is controllable wirelessly using devices such as a personal digital assistant (PDA) device 14 or via a base station 16 that is connected to a remote user using conventional networking technologies and protocols, such as the Ethernet. Both PDA 14 and base station 16 have an antenna for transmitting/receiving signals wirelessly and can use a number of different architectures and protocols, such as ZigBee® or Bluetooth®. Each PDA 14 and base station 16 can control any number of power cords or cables 10 and the identification or serial number for each cable or cord provides a means for uniquely addressing each cable or cord.

PDA 14 may include a universal serial bus (USB) port for connecting to a dongle which enables PDA 14 to monitor and control ZigBeee devices. Although other devices are available, an example of such a dongle is Integration's IA OEM-DAUB1 2400. More specifically, this will allow an operator to send command signals from PDA 14 to control power control switch device 12.

Although PDA 14 and base station 16 are shown, any wireless capable device can be used to control device 12 in cable 10. The term “control unit” will be used to generally refer to these types of devices since they are exemplary platforms for delivering desired functionality and any similar functional platform is also envisioned by the invention. In addition to the above and by no means limiting, a control unit can also be any wireless capable personal computer or a simple Ethernet wireless to wired bridge. Any standard protocol such as intelligent platform management interface (IPMI) or a command line interface (CLI) running on top of transmission control protocol/internet protocol (TCP/IP) is suitable for the purposes of the invention. Moreover, since the connection transport protocol is TCP/IP, access can be done over a standard TCP/IP socket connection running an application with a graphical user interface (GUI). The type of interaction between a control unit and an inventive cable is a client server system.

Power cord or power cable 10 is exemplified by International Electrotechnical Commission (IEC) IEC32 and may have two connectors, male and female, so that it can be used as an extender cable for existing cables and thus enable power management of existing systems. Power cord or cable 10 can come in any length and can have peripheral functions, such as receptacles for connecting light bulbs.

### II. Exemplary Embodiment

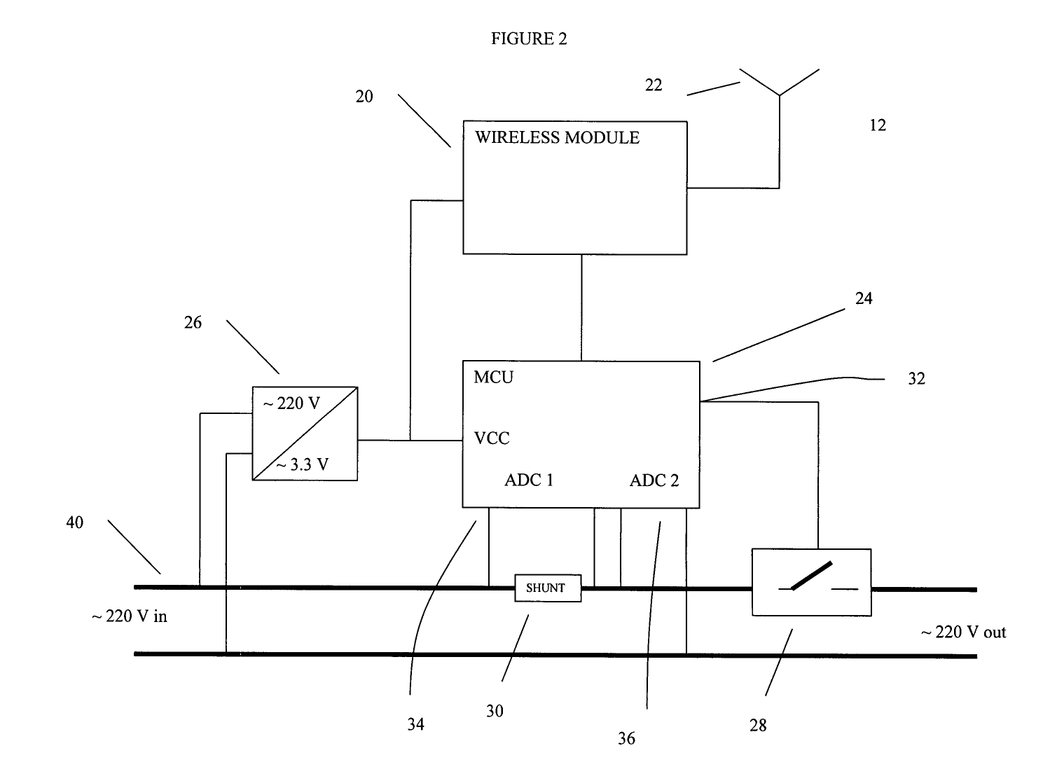

Referring now to FIG. 2, there is shown an exemplary schematic diagram of a circuit for power control switch device 12 shown in FIG. 1. Specifically, power control switch device 12 includes a wireless unit 20 such as a wireless transceiver with an antenna 22 to transmit and/or receive wireless signals. A microcontroller unit (MCU) 24 is connected to wireless unit 20, a power converter 26, a switch 28, and a shunt 30. Shunt 30 and switch 28 are positioned on input power line 40 as shown in FIG. 2. Power converter 26 is also connected to input power line 40 and is further connected to wireless unit 20, which in turn is connected to antenna 22. Although MCU 24 and wireless unit 20 are shown as two components in FIG. 2, MCU 24 and wireless module 20 can be implemented using one component.

Specifically, MCU 24 can be any off the shelf MCU, e.g., a PIC 8 bit or a 8051 compliant 16 bit processor. As shown in FIG. 2, MCU 24 is powered by a power converter 26. In the simplest case, MCU 24 can be powered using conventional power conversion circuitry, such as a resistor divider network and diodes, which generate low voltage direct current out of high voltage alternating current.

MCU 24 further includes an analog-to-digital converter (ADC) that has two inputs ADC1 34 and ADC2 36. As illustrated in FIG. 2, ADC2 36 is used to measure the voltage and ADC1 34 is used to measure the voltage difference on shunt 30, which can be directly converted into a measure of the current. Current and voltage measurements enable calculation of power consumption and true RMS (Root mean square) power consumption of the device(s) powered by input power through power cable 10. The embodiment shown in FIG. 2 is illustrative and other functionally equivalent circuits may be used. Note that a transformer (not shown) is used to convert the high voltage on cable 10 ( 110/220 V) to a level that can be measured by MCU 24.

One data channel of MCU 24 (not pictured), which can be implemented as a I²C, serial or any other similar architecture, is connected to wireless unit 20.

Wireless unit 20 uses Bluetooth®, ZigBee® or any other standard protocol for wireless communications. Specifically, wireless unit 20 implements the transmission control protocol/internet protocol (TCP/IP) stack and connectivity setup, including address, gateway, access port ID, and other functions. Consequently, MCU 24 only needs to handle the reading of the analog inputs and the switching of the digital output. This results in a minimal requirements set for MCU 24. There are wireless transceiver modules available in the market having the desired wireless access functionality that can be molded into power cable 10. These include, but are not limited to, for example, the Lantronix® WIPort and Chipcon® CC2431.

As shown in FIG. 2, switch 28 is connected to a digital output 32 of MCU 24. Switch 28 is turned on or off by command signals from MCU 24. Thus, the operator of a control unit, such as PDA device 12 or base station 14, has the ability to direct MCU 24 to turn on or off switch 28.

### Ill. Operational Description

In general, device 12 is initialized with a certain set of requirements and in response to certain events, specific actions are carried out. In both instances, most of these requirement settings and actions are carried out by establishing a wireless connection between the control unit and device 12 and then using a graphical user interface (GUI) on the control unit to set the appropriate requirements or take the appropriate actions. As evidenced by the list below, some actions are triggered automatically and require no further control unit interaction.

With respect to general setup information, the following need to be designated: setting user rights, designating device name and address, and designating recipients for alerts.

With respect to actions, the following actions may be initiated: turning on/off the switch (connect/disconnect), setting voltage/current threshold for automated turn off (soft circuit breaker), setting alert threshold for voltage and current, setting alert target, setting status on default (on or off), setting soft circuit breaker and alert behavior (to act immediately or to act after a time period has elapsed or to be inactive), measuring current (amps), measuring voltage (volts), and measuring power consumption (watts).

As evident from the above, device 12 has the following functions: switch on or off, provide actual current, provide actual voltage, provide actual power consumption, realize a soft circuit breaker and provide root mean square power consumption.

There are three basic processes operating that enable power monitoring and management.

The first process runs essentially on MCU 24. MCU 24 has control over all the in/out signals connected to the circuit shown in FIG. 2. The first process constantly polls the data of the sensors, for example, voltage and current data, and stores them in a database inside MCU 24 memory (not shown). The database can take the form of a table or any other relational structure. This process runs all the time regardless of whether there is any interaction between a control unit, such as PDA 14 or base station 16, and MCU 24.

The second process is an interactive process running between MCU 24 and the control unit. The second process includes a process running on the control unit that offers a network server IP interface in the listening mode. In addition, wireless unit 20 acts as network interface hardware for encapsulating the IP packets exchanged between the control unit and MCU 24 into wireless packets for communication over standard wireless protocols such as ZigBee® or Bluetooth®.

The control unit owns client software that triggers certain actions. User interaction on the GUI on the control unit is needed to start one of these actions. Actions may include but are not limited to, “read sensor data”, set switch status”, set MCU internal value (e.g. IP address, . . . ).

Specifically the software on the control unit will start an IP connection to the IP server process of MCU 24 using the wireless OSI layer 1 and layer 2 functionality. Once the TCP/IP connection is established, a command is sent to MCU 24 and a response is created according to the data in the database (in case of a read command) or an action of MCU 24 is triggered (MCU 24 is switching switch 28). A successful action creates a notification back to the control unit which triggers the termination of the connection.

A third process runs in MCU 24 and monitors thresholds set by set commands from the control unit, such as PDA 14. In the event a voltage/current threshold is reached, a pre-defined action is performed. For example, a possible action is switching switch 28 to on or off.

While the foregoing description and drawings represent the preferred embodiments of the present invention, it will be understood that various changes and modifications may be made without departing from the spirit and scope of the present invention.

What is claimed is:

1. A device, comprising:
a power cable; and
a power control module molded into the power cable,
wherein the device is wirelessly controlled through the power control module.

2. The device of claim 1, wherein the power cable has a type one connector at one end and a type two connector at a remaining end.

3. The device of claim 1, wherein the power control module comprises a wireless module for wireless communications.

4. The device of claim 1, wherein the device is controlled by a wireless device.

6. The device of claim 1, wherein the device is controlled by a wireless station connected via a network.

7. The device of claim 4, wherein the wireless module uses a ZigBee® or Bluetooth® protocol.

8. The device of claim 1, wherein the power control module comprises:
a controller;
a wireless module connected to the controller, wherein the controller and the wireless module work together to set received thresholds; and
a switch connected to the controller, wherein the controller activates the switch in response to achieving the thresholds.

9. The device of claim 8, wherein the controller and the wireless module activate the switch in response to a received command.

10. The device of claim 1, wherein the power cable is IEC32.

11. The device of claim 1, wherein the power control module is responsive to meeting at least one threshold.

12. The device of claim 1, wherein the power control module is responsive to a received command.

13. A power cord, comprising:
a power control module molded into the power cord,
wherein the power cord is wirelessly controlled through the power control module.

14. The power cord of claim 13, wherein the power control module comprises a wireless module for wireless communications.

15. The power cord of claim 13, wherein the device is controlled by a wireless device.

16. The power cord of claim 13, wherein the power control module comprises:
a controller;
a wireless module connected to the controller, wherein the controller and the wireless module set received thresholds; and
a switch connected to the controller, wherein the controller activates the switch in response to achieving the thresholds.

17. The power cord of claim 16, wherein the controller and the wireless module activate the switch in response to a received command.

18. The power cord of claim 13, wherein the power control module responds to commands, acts on meeting at least one threshold and collects and transmits data.
